(19) United States
(12) Patent Application Publication
(10) Pub. No.: US 2004/0153975 A1
(43) Pub. Date: Aug. 5, 2004

(54) Text entry mechanism for small keypads

(76) Inventors: Roland E. Williams, Pleasant Hill, CA (US); Robert B. O'dell, Oakland, CA (US)

Correspondence Address: JAMES D IVEY, 3025 TOTTERDELL STREET, OAKLAND, CA, 94611-1742, US

(21) Appl. No.: 10/360,537

(22) Filed: Feb. 5, 2003

(51) Int. Cl. G06F 17/21

(52) U.S. Cl. 715/531

(57) ABSTRACT

A data entry mechanism for reduced keypads uses relative frequency of usage of bigrams to assist the user. The first character specified by a user is specified unambiguously, the second character specified by the user is also unambiguously specified but efficiency is enhanced by using relative frequency of usage of bigrams, and the remaining characters are specified by single key presses and most likely intended words are predicted according to frequency of usage of words matching the keys pressed by the user. Similarly, the third character can be also interpreted using relative frequency of usage of trigrams which include the first two entered characters. Fourth and subsequent characters can also be interpreted in the context of relative frequency of usage of other n-grams.

### FIELD OF THE INVENTION

This invention relates to the field of text entry in electronic devices, and more specifically to a mechanism which is both efficient and intuitive to the user for entering text in a reduced keypad.

### BACKGROUND OF THE INVENTION

The dramatic increase of popularity of the Internet has led to a corresponding dramatic rise in the popularity of textual communications such as e-mail and instant messaging. Increasingly, browsing of the World Wide Web of the Internet and textual communications are being performing using reduced keypads such as those found on mobile telephones.

Multi-tap systems provide usable but less than convenient text entry functionality for users of the Roman alphabet. Briefly, multi-tap systems determine a number of repeated presses of a key to disambiguate multiple letters associated with a single key. For example, pressing the “2” key once represents the letter “a”; pressing the “2” key twice represents the letter “b”; pressing the “2” key thrice represents the letter “c”; and pressing the “2” key four (4) times represents the numeral “2.” The number of presses of a particular key is typically delimited with a brief pause. While feasible, entering textual data of the Roman alphabet using multi-tap is cumbersome and time-consuming.

Some attempts have been made to use predictive interpretation of key presses to disambiguate multiple written symbols associated with individual keys. Such predictive interpretation is described by Zi Corporation at http://www.zicorp.com on the World Wide Web and in U.S. Pat. No. 5,109,352 to Robert B. O'Dell (hereinafter the O'Dell Patent). Predictive interpretation is generally effective and greatly simplifies text input using reduced keypads and very large collections of written symbols. However, predictive interpretation has difficulty with words used in proper nouns, slang, and neology as such words might not be represented in a predictive database.

Despite its great efficiency, predictive interpretation of key presses for disambiguation provides a somewhat less than intuitive user experience. In particular, predictive interpretation lacks accuracy until a few characters have been specified. The following example is illustrative.

Consider that a user is specifying the word “forest” using a numeric telephone keypad. In predictive interpretation, the user presses the following sequence of keys: 3-6-7-3-7-8. It should be appreciated that entering “forest” using multi-tap is significantly more cumbersome, pressing 3-3-3, pausing, pressing 6-6-6, pausing, pressing 7-7-7, pausing, pressing 3-3, pausing, pressing 7-7-7-7, pausing, pressing 8, and pausing. In predictive interpretation, pressing “3” by the user does not necessarily interpret and display “f” as the indicated letter. Instead, an “e” or a “d” could be displayed to the user as the interpretation of the pressing of the “3” key. In some predictive interpretation implementations, the entire predicted word is displayed to the user. Since numerous words begin with any of the letters d, e, or f, it is rather common that the predicted word is not what the user intends to enter. Thus, as the user presses the “3” key to begin spelling “forest,” an entirely different word such as “don't” can be displayed as a predicted word.

As the user presses the second key in spelling “forest,” namely, the “6” key, some word other than “forest” can continue to be displayed as the predicted word. What can be even more confusing to the user is that the predicted word can change suddenly and dramatically. For example, pressing the “6” key can change the predicted word from “don't” to “eminently”—both of which are spelled beginning with the “3” key followed immediately by the “6” key—depending upon frequency of usage of those respective words. To obtain full efficiency of predictive interpretation systems, the user continues with the remainder of the sequence—finishing with 7-3-7-8. Once the full sequence is entered, only one word—or just a few words—match the entered sequence. However, until that point is reached, the user is required to place faith and trust that the predictive interpretation will eventually arrive at the correct interpretation notwithstanding various incorrect interpretations displayed early in the spelling of the desired word.

What is needed is an improved mechanism for efficiently disambiguating among multiple symbols associated with individual keys of a reduced keypad while continuing to provide accurate and reassuring feedback to the user.

### SUMMARY OF THE INVENTION

In accordance with the present invention, characters entered using a reduced keypad are interpreted according to frequency of appearance of characters adjacent to one another. For example, a first character can be entered using a non-ambiguous mechanism such as multi-tap and a second character is entered in a manner in which the relative frequency of appearance of the second character immediately following the first character influences the interpretation of the entered character.

The following example is illustrative. Suppose that a user is entering a word using a telephone keypad to specify letters of the English language. Suppose further that the user has unambiguously specified that the first letter is “f.” Next, the user in this illustrative example presses the “6” key of the telephone keypad which represents the letters “m,” “n,” and “o.” To properly interpret this user input gesture; the relative frequency of appearance of “μm,” “n,” and “o” adjacent to the letter “f” in usage of the English language. In other words, the relative frequency of usage of the bigrams, “fm,” “fn,” and “fo,” are determined.

As used herein, a bigram is a string of two letters. For example, the word, “smile,” includes the following bigrams: “sm,” “mi,” “il,” and “le.” As used herein, a trigram is a string of three letters. Thus, the work, “smile,” includes the following trigrams: “smi,” “mil,” and “ile.” Continuing in the illustrative example involving the bigrams “fm,” “fn,” and “fo,” consider that the bigram “fo” appears most frequently in English usage, the bigram “fn” appears the second-most frequently, and the bigram “fm” appears the least frequently. Accordingly, a single press of the “6” key on the telephone keypad is interpreted as representing the letter “o” rather than the letter “m” as it is on traditional multi-tap systems. Two presses of the “6” key is interpreted as the letter “n” in this example. And three presses of the “6” key is interpreted as the letter “m.” Thus, the sequence of characters represented by a given key is dependent on the prior specified character. For example, the order of characters represented by the “6” key following specification of the letter “a” can be as follows: “n” first, “m” second, and “o” third. Such would be the case if the bigram “an” was most frequently used, the bigram “am” second most frequently used, and “ao” the least frequently used.

Once the user has specified the first character unambiguously and the second character unambiguously in the enhanced manner described above using relative bigram frequency, subsequent characters are interpreted using predictive analysis based on a dictionary of words and a personal dictionary of words used by previously by the user. With the first two characters specified unambiguously, the likelihood of predicted words which appear to be dramatically different from the word intended by the user is substantially reduced. In particular, words like “don't” and “eminently” will not be displayed to the user during entry of “forest” because the “f” and “o” are specified unambiguously.

At the same time, data entry according to the present invention is quite efficient. In the example given above in which the user enters the word, “forest,” multi-tap required 16 key pressed and predictive analysis required only six (6)—one for each letter. In the example given above, the user specified the letter “f” using multi-tap, e.g., pressing the “3” key thrice. Since the bigram “fo” is more commonly than “fm” and “fn,” a single press of the “6” key is correctly interpreted as the letter “o.” The remainder of the entry of “forest” is by predictive analysis. Accordingly, the full sequence to enter “forest” is 3-3-3-6-7-3-7-8—eight (8) key presses. Thus, data entry according to the present invention is nearly as efficient as predictive analysis mechanisms yet the user's experience is significantly improved by elimination of display of apparently unrelated predicted words to the user.

Thus, in accordance with the present invention, the first character specified by a user is specified unambiguously, the second character specified by the user is also unambiguously specified but efficiency is enhanced by using relative frequency of usage of bigrams, and the remaining characters are specified by single key presses and most likely intended words are predicted according to frequency of usage of words matching the keys pressed by the user. Similarly, the third character can also be interpreted using relative frequency of usage of trigrams which include the first two entered characters. Fourth and subsequent characters can also be interpreted in the context of relative frequency of usage of other n-grams.

### BRIEF DESCRIPTION OF THE DRAWINGS

FIG. 1 shows a device which implements data entry in accordance with the present invention.

FIG. 2 is a block diagram showing showing some of the functional components of the device of FIG. 1.

FIG. 3 is a logic flow diagram illustrating data entry in accordance with the present invention.

FIG. 4 is a logic flow diagram showing a portion of the logic flow diagram of FIG. 3 in greater detail.

FIGS. 5A and 5B illustrate a data structure in which relative usage frequency of bigrams is represented.

FIG. 6 is a logic flow diagram showing a portion of the logic flow diagram of FIG. 3 in greater detail.

FIG. 7 is a block diagram of the predictive database of FIG. 2 in greater detail.

FIG. 8 is a block diagram of a data structure used in data entry in accordance with the present invention.

FIG. 9 is a portion of a logic flow diagram illustrating data entry according to an alternative embodiment of the present invention.

FIG. 10 is a block diagram of a data structure used in data entry in accordance with the present invention.

FIGS. 11-18 represent screen views during data entry in accordance with the present invention.

FIG. 19 is a logic flow diagram illustrating population of a personal dictionary for use in data entry in accordance with the present invention.

### DETAILED DESCRIPTION

In accordance with the present invention, a first character of a text message is unambiguously specified by a user such that accuracy of predictive interpretation of subsequent key presses is significantly improved. In particular, the first character can be specified unambiguously using multi-tap for example. A second character is predicted according to frequently occurring bigrams of the particular language in which the user is writing, i.e., the native language. Subsequent letters are interpreted according to frequency of matching words of the native language.

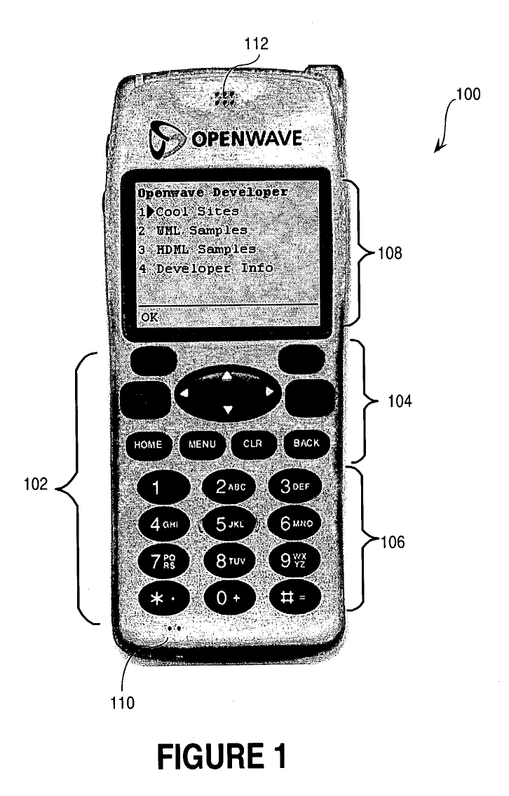

FIG. 1 shows a mobile telephone 100 which is used for textual communication. For example, mobile telephone 100 can be used to send and receive textual messages and/or can be used to browse the ubiquitous World Wide Web according to the known and standard Wireless Application Protocol (WAP). Mobile telephone 100 can also be used, in this illustrative embodiment, to send text messages according to the currently available and known Short Message Service (SMS). Mobile telephone 100 includes a keypad 102 which includes both command keys 104 and data input keys 106. In addition, mobile telephone 100 includes a display screen 108. In addition, mobile telephone 100 includes a microphone 110 for receiving audio signals and a speaker 112 for presenting audio signals.

Data entry keys 106, which are sometimes referred to herein collectively as numeric keypad 106, are arranged in the typical telephone keypad arrangement as shown. While numeric keypad 106 is described herein as an illustrative example of a reduced keypad, it should be appreciated that the principles of the present invention are applicable to other reduced keypads. As used herein, a reduced keypad is a keypad in which one or more keys can each be used to enter one of a group of two of more symbols. For example, the letters “a,” “b,” and “c” are associated with, and specified by a user pressing, the “2” key of numeric keypad 106.

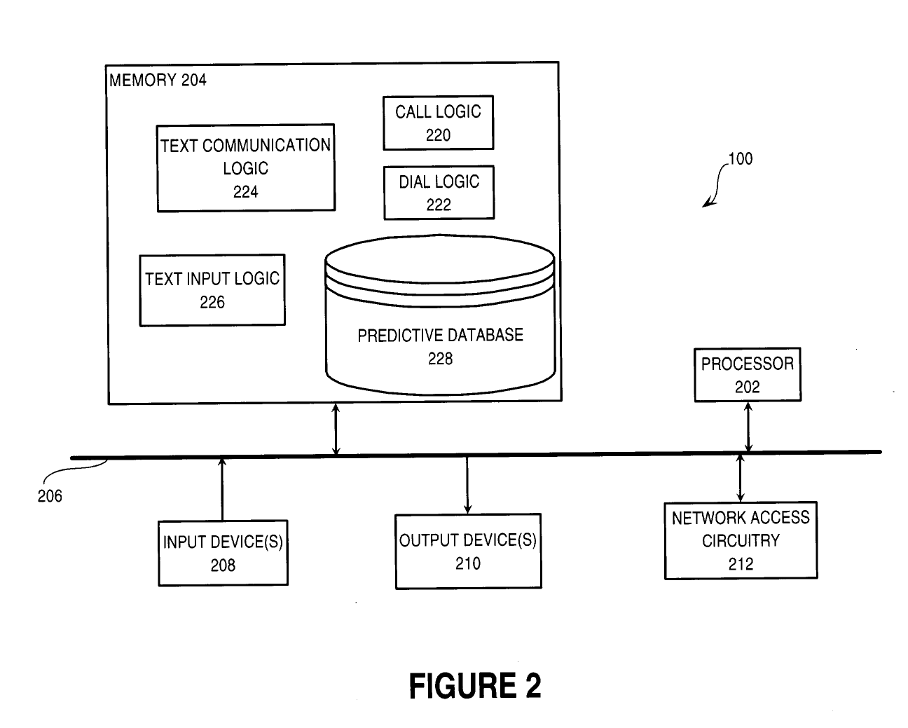

Some elements of mobile telephone 100 are shown in diagrammatic form in FIG. 2. Mobile telephone 100 includes a microprocessor 202 which retrieves data and/or instructions from memory 204 and executes retrieved instructions in a conventional manner.

Microprocessor 202 and memory 204 are connected to one another through an interconnect 206 which is a bus in this illustrative embodiment. Interconnect 206 is also connected to one or more input devices 208, one or more output devices 210, and network access circuitry 212. Input devices 208 include, for example, keypad 102 (FIG. 1) and microphone 110. In alternative embodiments, input devices 208 (FIG. 2) can include other types of user input devices such as touch-sensitive screens, for example. Output devices 210 include display 108 (FIG. 1), which is a liquid crystal display (LCD) in this illustrative embodiment, and speaker 112 for playing audio received by mobile telephone 100 and a second speaker for playing ring signals. Input devices 208 and output devices 210 can also collectively include a conventional headset jack for supporting voice communication through a convention headset. Network access circuitry 212 includes a transceiver and an antenna for conducting data and/or voice communication through a network.

Call logic 220 is a collection of instructions and data which define the behavior of mobile telephone 100 in communicating through network access circuitry 212 in a conventional manner. Dial logic 222 is a collection of instructions and data which define the behavior of mobile telephone 100 in establishing communication through network access circuitry 212 in a conventional manner. Text communication logic 224 is a collection of instructions and data which define the behavior of mobile telephone 100 in sending and receiving text messages through network access circuitry 212 in a conventional manner.

Text input logic 226 is a collection of instructions and data which define the behavior of mobile telephone 100 in accepting textual data from a user. Such text entered by the user can be sent to another through text communication logic 224 or can be stored as a name of the owner of mobile telephone 100 or as a textual name to be associated with a stored telephone number. As described above, text input logic 226 can be used for a wide variety of applications other than text messaging between wireless devices. Predictive database 228 stores data which is used to predict text intended by the user according to pressed keys of input devices 208 in a manner described more completely below.

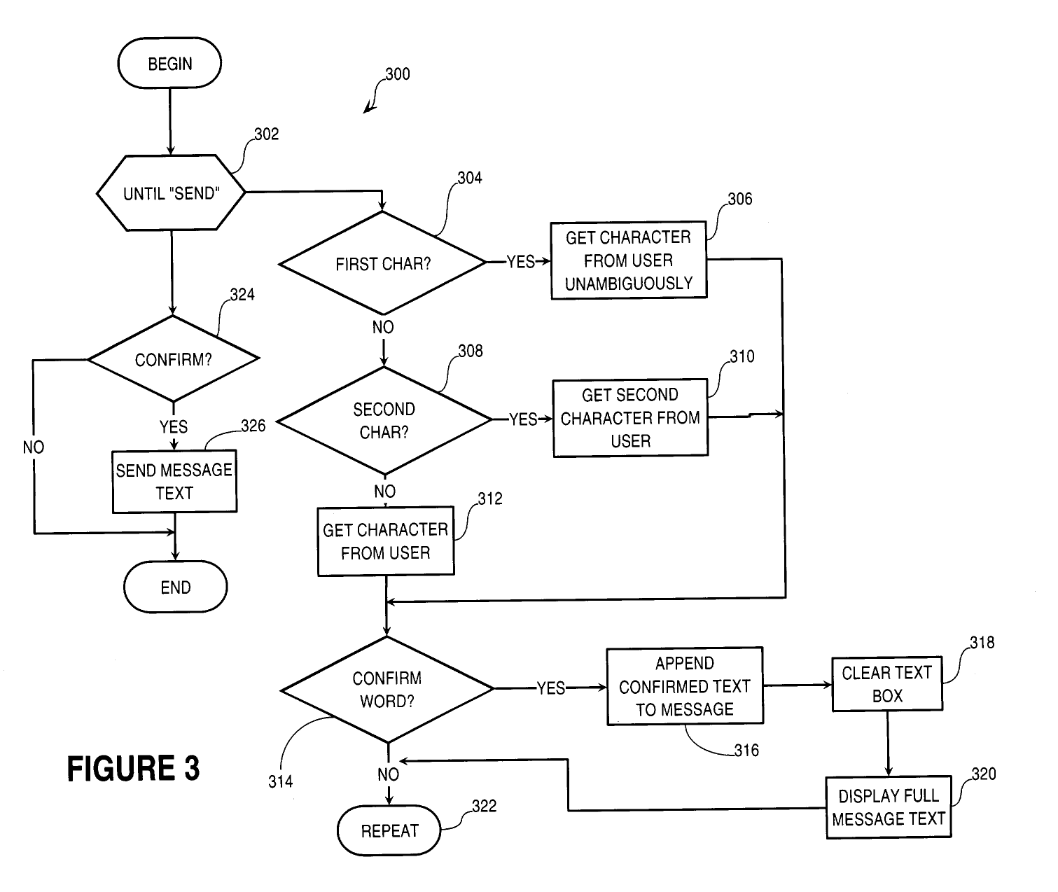

Logic flow diagram 300 (FIG. 3) illustrates the behavior mobile telephone 100 (FIG. 2) according to text input logic 226 of this illustrative embodiment. Loop step 302 (FIG. 3) and next step 322 define a loop in which words or phrases are entered by the user according to steps 304-320 until the user indicates that the message is complete. In this illustrative embodiment, the user indicates that the message is complete by invoking a “send” command, e.g., by pressing a “send” button on keypad 102 (FIG. 1). For each word or phrase, processing transfers to test step 304.

In test step 304, text input logic 226 (FIG. 2) determines if the user is specifying the first character of a word or phrase. In this illustrative embodiment, text input logic 226 determines that the user is specifying the first character of a word or phrase by determining whether the current performance of the loop of steps 302-322 is the first performance of the loop of steps 302-322 or whether the user confirmed a word or phrase in the immediately preceding performance of the loop of steps 302-322. Such confirmation is described more completely below. If the user is not specifying the first character of a word or phrase, processing transfers to test step 308 which is described below.

Conversely, if the user is specifying the first character of a word or phrase, processing transfers to step 306. In step 306, text input logic 226 (FIG. 2) interprets user-generated input signals as specifying a character in an unambiguous manner. In this illustrative embodiment, the user specifies the first character of the word or phrase using multi-tap. As described more completely herein, unambiguous specification of the first letter greatly improves the accuracy of prediction of subsequent characters of a word or phrase.

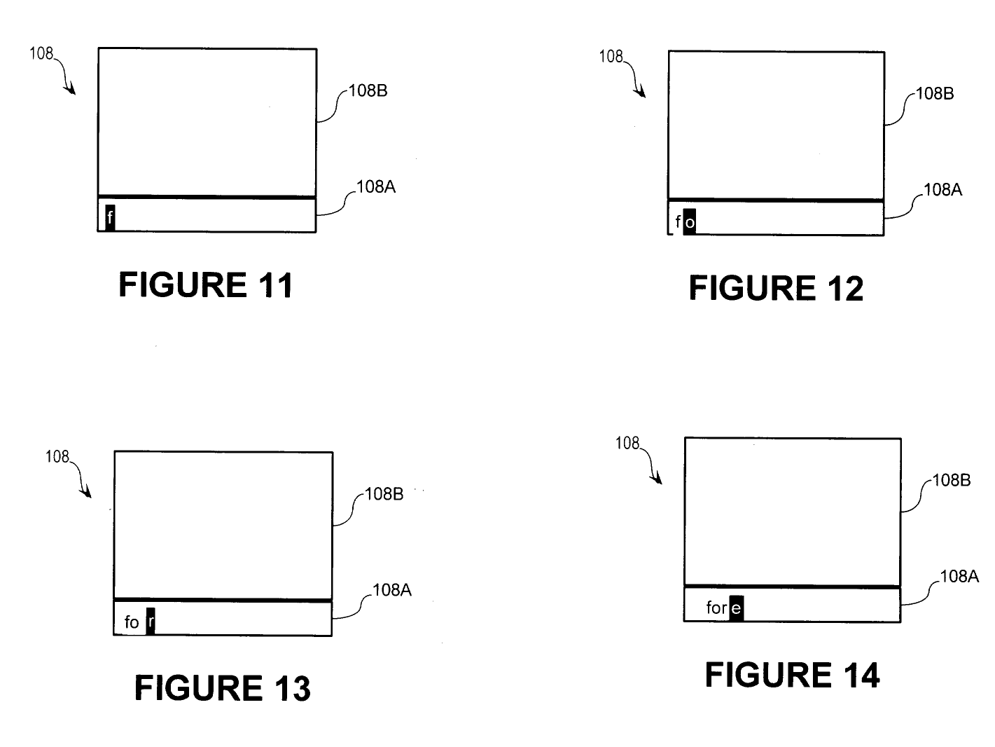

User specification of text according to the present invention is described in the context of an illustrative example of the user specifying the word, “forest.” FIG. 11 shows display 108 of mobile telephone 100 (FIG. 1) in which display 108 is divided logically, i.e., by text input logic 226 (FIG. 2), into an upper portion—window 108B (FIG. 11)—and a lower portion—window 108A. Window 108A displays a current word, i.e., the word currently being specified by the user. Window 108B displays previously specified words which have been confirmed by the user and therefore appended to a current message which can include multiple words. In the current performance of step 306 (FIG. 3), the user specifies the letter “f” using multi-tap user interface techniques, e.g., by pressing the “3” key three (3) times and pausing to confirm the specification of the letter “f.” The results are shown in FIG. 11 in which the letter “f” is displayed in window 108A. In this illustrative example, the user has not previously specified any words so window 108B is empty. In an alternative embodiment, text is edited in-line in window 108A which shows both completed and partial words, and window 108B is omitted.

After step 306 (FIG. 3), processing transfers to test step 314 in which text input logic 226 determines whether the user confirms the current word. The user confirms the current word in this illustrative embodiment by pressing a predetermined one of control buttons 104 (FIG. 1) of keypad 102. If the user has confirmed the current word, processing transfers to step 316 (FIG. 3) which is described below. Conversely, if the user has not confirmed the current word, processing transfers through repeat step 322 to loop step 302 and the next character specified by the user is processed according to steps 302-322. In this illustrative embodiment, the user continues to specify a second character using numeric keypad 106 and therefore does not confirm the current word. Accordingly, text input logic 226 performs another iteration of the loop of steps 302-322.

In this subsequent iteration, the user is no longer specifying the first character of the word. Accordingly, processing by text input logic 226 transfers from test step 304 to test step 308.

In test step 308, text input logic 226 determines whether the user is specifying the second character of the current word. In this illustrative embodiment, the user is specifying the second character if the user specified the first character of the current word in the immediately preceding iteration of the loop of steps 302-322. If the user is not specifying the second character of the current word, processing by text input logic 226 (FIG. 2) transfers to step 312 which is described below.

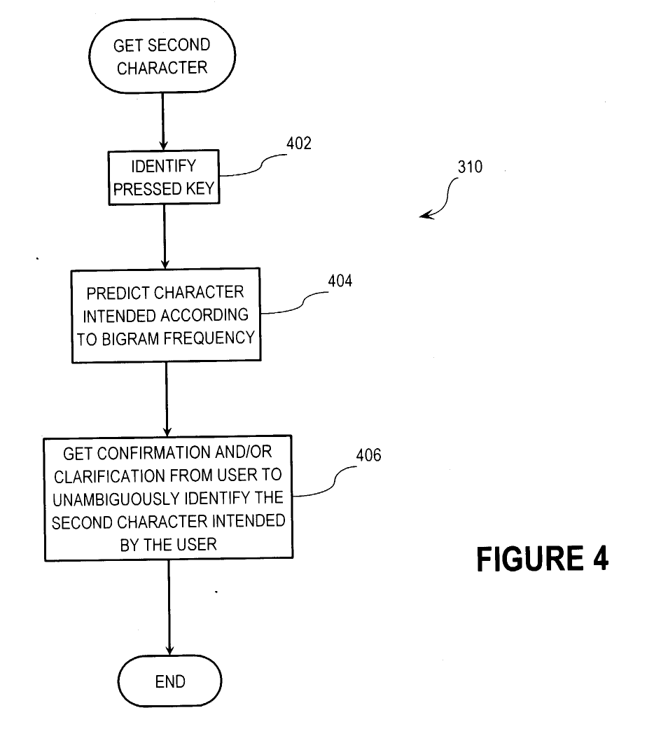

Conversely, if the user is specifying the second character of the current word, processing transfers to step 310. In step 310, text input logic 226 interacts with the user to determine the second character of the current word as intended by the user. Step 310 is shown more completely as logic flow diagram 310 (FIG. 4).

In step 402, text input logic 226 (FIG. 2) determines the specific key pressed by the user in specifying the second character. In this illustrative example, the user presses the “6” key to specify the letter “o” in “forest.” In step 404 (FIG. 4), text input logic 226 (FIG. 2) predicts which character the user intends according to relative frequency of appearance of bigrams beginning with the letter “f.” In this case, the user has pressed the “6” key which represents letters “m,” “n,” and “o.” Accordingly, three possible bigrams are associated with the letter “f” followed by pressing of the “6” key, namely, “fm,” “fn,” and “fo.”

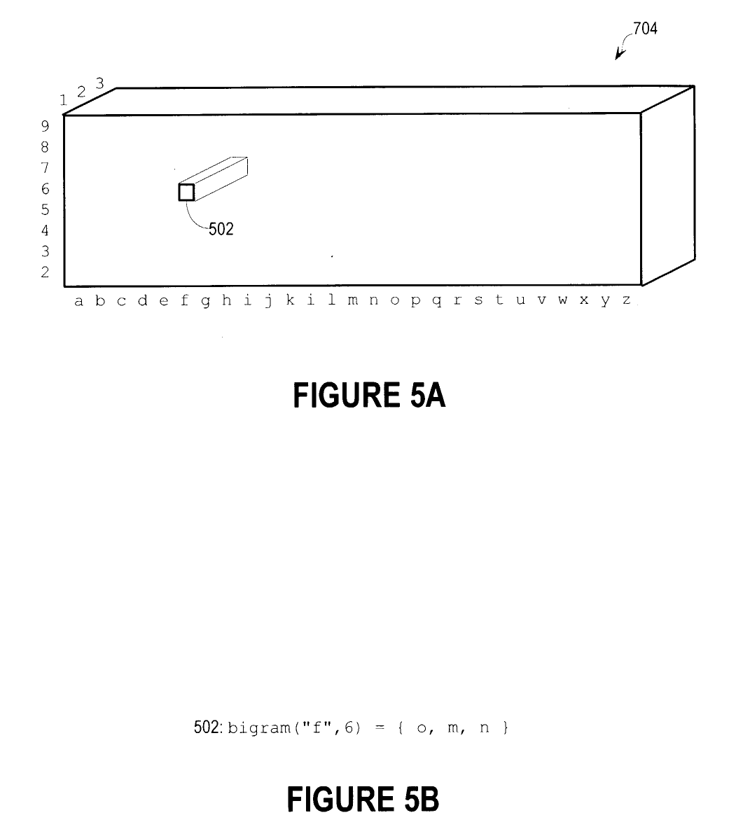

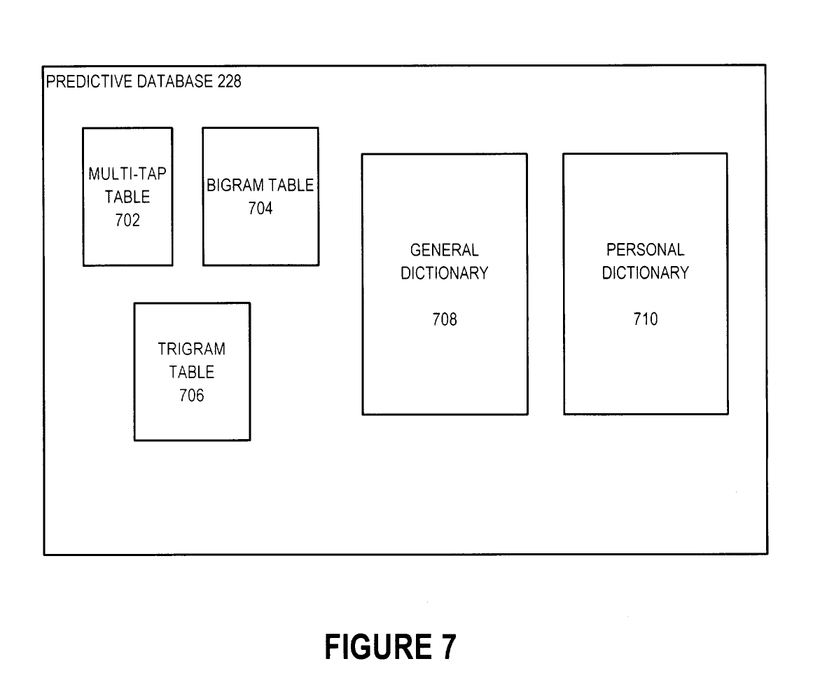

In this illustrative embodiment, text input logic 226 predicts the second character according to relative frequency of appearance of bigrams by reference to a pre-populated bigram table 704 (FIG. 5A) which is a part of predictive database 228 as shown in FIG. 7. Bigram table 704 (FIG. 5A) is 3-dimensional in which the three dimensions are (i) characters representing possible first characters of the current word, (ii) keys which can be used by the user to specify the second character of the current word, and (iii) an ordered list of possible second characters. Element 502 represents the ordered list of possible second characters when the first character is the letter “f” and the second character corresponds to the “6” key. As shown in FIG. 5B, the ordered list is “o,” “m,” and “n.” Thus, bigram table 704 represents that the most frequently appearing bigram which begins with the letter “f” and ends with a character associated with the “6” key is “fo.” The second most frequently appearing bigram of the same set as represented in bigram table 704 is “fm.” The least frequently appearing bigram of the same set as represented in bigram table 704 is “fn.”

Accordingly, text input logic 226 (FIG. 2) predicts that the user intends to enter the letter “o” by pressing the “6” key in step 404 (FIG. 4) since “fo” is the most frequently appearing bigram beginning with the letter “f” and including a letter associated with the “6” key. Text input logic 226 therefore displays the letter “o” in window 108A (FIG. 12) as the predicted second letter.

In step 406 (FIG. 4), text input logic 226 allows the user to unambiguously specify the second character by confirming or clarifying the predicted interpretation of the pressing of the “6” key. In this illustrative embodiment, text input logic 226 does so by treating ordered list 502 as a revised ordering of characters interpreted according to a multi-tap mechanism. Thus, to accept the letter “o” as the proper interpretation of the pressing of the “6” key, the user simply pauses briefly. Text input logic 226 interprets this brief pause as a confirmation of the predicted interpretation, namely, the letter “o.” If the user wishes to clarify the interpretation, the user presses the “6” key again without pausing to change the interpretation to the letter “m” and again without pausing to change the interpretation to the letter “n.” However, in this illustrative example, the initial predicted interpretation is correct so the user merely pauses briefly to confirm the second letter.

Since the predicted interpretation of the second letter is based on bigram frequency, most often the initial predicted interpretation will be correct and key presses required by the user to specify the second character is reduced. In this illustrative embodiment, non-letter characters are kept in the multi-tap interpretation at the end of the letters of ordered list 502. In particular, the user can press the “6” key four times before pausing to specifying the numeral “6.”

After step 406, processing according to logic flow diagram 310, and therefore step 310 (FIG. 3), completes. In an alternative embodiment described below, a dictionary specific to the user is also used to predict the second character of the current word. After step 310, processing transfers to test step 314 in which text input logic 226 determines whether the user has confirmed the current word in the manner described above, and the next character entered by the user is processed according to steps 302-322.

In this illustrative example, the user does not confirm the current word and text input logic 226 performs another iteration of the loop of steps 302-322. Since this is the third character specified by the user, processing by text input logic 226 passes through test steps 304 and 308 to step 312.

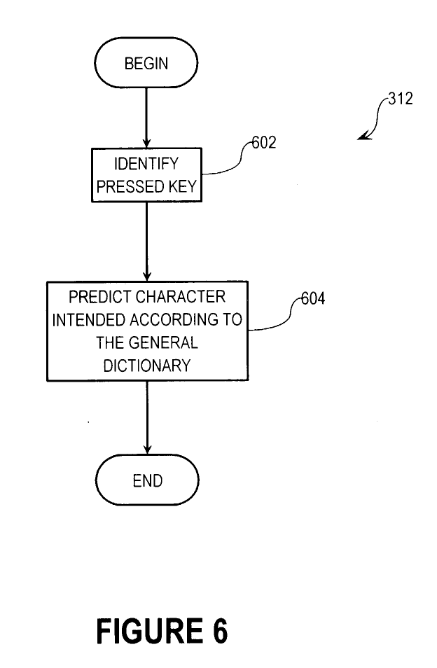

Step 312 is shown in greater detail as logic flow diagram 312 (FIG. 6). In step 602, text input logic 226 determines which key is pressed by the user in the manner described above with respect to step 402 (FIG. 4). In step 604 (FIG. 6), text input logic 226 predicts the character intended by the user according to a general dictionary of words of one or more languages expected by text input logic 226. In this illustrative embodiment, text input logic 226 expects words of the English language.

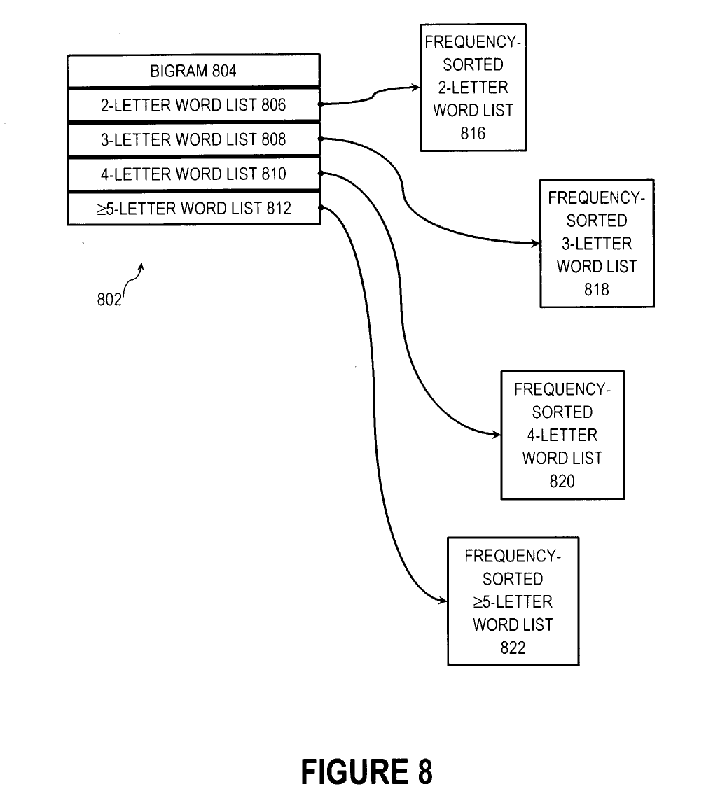

A portion of general dictionary 708 is shown in greater detail in FIG. 8 to illustrate the various relationships of data stored therein to facilitate predictive analysis in the manner described herein. Each bigram of bigram table 704 has an associated bigram record 802. For example, element 502 (FIGS. 5A-B) of bigram table 704 represents an ordered list of three bigrams. In this illustrative embodiment, element 502 associates, with each of the three bigrams represented within element 502, a pointer to an associated bigram record within general dictionary 708. An example of such a bigram record is shown as bigram record 802 (FIG. 8).

Bigram record 802 includes a bigram field 804 which identifies the bigram represented by bigram record 802. In an alternative embodiment, bigram field 804 is omitted and the identity of the represented bigram is inferred from the association within an element, e.g., element 502, of bigram table 704. Bigram record 802 also includes a number of word list pointers 806-812, each of which refers to a respective one of ordered word lists 816-822.

Ordered word lists 816-822 each contain member words of general dictionary 708 which are ordered according to frequency of use. Thus, most frequently used words in each list are located first. Ordered word list 816 includes only member words which are two characters in length. Ordered word lists 818 and 820 include only members words which have lengths of three and four characters, respectively. Ordered word list 822 includes only member words which have lengths of at least five characters. The segregation of words beginning with the bigram represented in bigram field 804 into separate lists of various lengths allows text input logic 226 to prefer words which match the user's input in length over those which exceed the length of the user's input thus far. For example, it's possible that, in words beginning with the bigram “fo,” that “s” (associated with the “7” key of a telephone keypad) more frequently follows “fo” than does “r.” However, “for” is a complete word and it would seem more natural to a user that text input logic 226 would assume a complete word rather than a beginning part of a longer word. Such presents a more natural and comfortable user experience.

Thus, by reference to general dictionary 708 in step 604 (FIG. 6), text input logic 226 (FIG. 2) collects all words of general dictionary 708 which include all letters unambiguously specified thus far, e.g., the first two letters in this illustrative example, and which include a letter in the current letter position, e.g., third in this illustrative example, corresponding to the most recently pressed key. In this illustrative example, the first two letter, namely, “f” and “o,” have been unambiguously specified and the user has most recently pressed the “7” key. Thus, in step 604, text input logic 226 retrieves all words of general dictionary 708 which begin with “f” and “o” and which include a third letter which is one represented by the “7” key, e.g., “p,” “q,” “r,” or “s.” In addition, text input logic 226 orders the list of words according to relative frequency of use of each word. In this illustrative embodiment, entries of general dictionary 708 are stored in order of relative frequency of use and that relative order is preserved by text input logic 226 in retrieving those words with the exception that words of exactly the length of the number of characters specified by the user so far are given higher priority.

In one embodiment, text input logic 226 predicts only a single character by selecting the corresponding character of the most frequently used word retrieved from general dictionary 708 and displays the current word including the predicted character in window 108A as shown in FIG. 13. In an alternative embodiment, text input logic 226 predicts the entire word by selecting the entirety of the most frequently used word retrieved from general dictionary 708 and displaying the entire word in window 108A as shown in FIG. 18. The predicted portion of the word is highlighted as shown in FIG. 18. Since the first two letters are unambiguously specified by the user, the predictive analysis of the third and subsequently specified characters is significantly improved over predictive analysis in which the first one or two letters are not unambiguously specified by the user. As a result, predicted characters or words are much more accurately predicted and the user experiences fewer instances of displayed incorrect interpretations of pressed keys. Accordingly, the user experience is greatly enhanced.

Text input logic 226 can provide a number of user interfaces by which the user can correct inaccurate input interpretation by text input logic 226. In the embodiment represented in FIG. 13 in which text input logic 226 predicts a single character according to general dictionary 708, the user can indicate an inaccurate interpretation by text input logic 226 by pressing the same key, e.g., the “7” key in this illustrative example, an additional time without pausing much like a multi-tap mechanism. In response to this quick re-pressing of the same key, text input logic 226 selects the next third character from the list of matching general dictionary entries ordered by frequency of use and interprets the quick re-press of the same key as representing that character. The following example is illustrative.

Consider that the words selected from general dictionary 708 include “for” and “forward” as most frequently used words beginning with “f” and “o” and having “p,” “q,” “r,” or “s” as the third character. Accordingly, in this embodiment, the first prediction as to the third character intended by the user is the letter “r” as shown in window 108A (FIG. 13). If the user presses the “7” key again without pausing, text input logic 226 searches down the ordered list from general dictionary 708 for the most frequently used word whose third letter is not “r.” In this illustrative example, words such as “fossil” and “foster” as sufficiently frequently used that text input logic 226 interprets the quick re-press of the “7” key as switching the predicted letter from “r” to “s.” The experience of the user is similar to multi-tap but the order in which the specific letters appears during the repeated presses is determined by the relative frequency of words using those letters in the corresponding position. When the user pauses, the letter is considered unambiguously specified by the user and step 604 completes.

In an alternative embodiment as shown in FIG. 18, text input logic 226 predicts the remainder of the word. Text input logic 226 can provide various user interfaces by which the user clarifies the predicted text. In one embodiment, text input logic 226 provides a multi-tap user interface similar to that described above except that the entirety of each predicted word is displayed such that the user can immediately confirm any predicted word. Each time the user pauses, a single letter of the predicted word at the current position is accepted and one less character of the predicted word is highlighted in a subsequent iteration of the loop of steps 302-322. Accordingly, the user clarifies a single letter at a time but can confirm an entire word if the predicted word is correct. Since the predicted word is selected according to frequency of use, the predicted word is correct in its entirety a substantial portion of the time.

In another alternative embodiment, text input logic 226 provides a multi-tap user interface in which each iterative key press by the user selects the next most frequently used word retrieved from general dictionary 708. Thus, iterative key presses scrolls through the ordered list of predicted words. Since the first two letters are unambiguously specified by the user and since the list is ordered by frequency of use of each word, the user can typically locate the intended word relatively quickly.

In yet another alternative embodiment, text input logic 226 no multi-tap mechanism is provided for clarification by the user. Instead, each key press by the user is interpreted by text input logic 226 as specifying a collection of letters for a corresponding character of the intended word. For example, once the “f” and “o” are unambiguously specified, the user presses the “7” key once to specify “r,” presses the “3” key once to specify “e,” presses the “7” key once more to specify “s,” etc. Pressing the same key twice is interpreted by text input logic 226 in this alternative embodiment as specifying two letters from the group of letters represented by the key.

Once the user clarifies the current letter in one of the manners described above, step 604, logic flow diagram 312, and therefore step 312 (FIG. 3) completes. After step 312, text input logic 226 performs steps 314-320 to process word confirmation by the user in the manner described above.

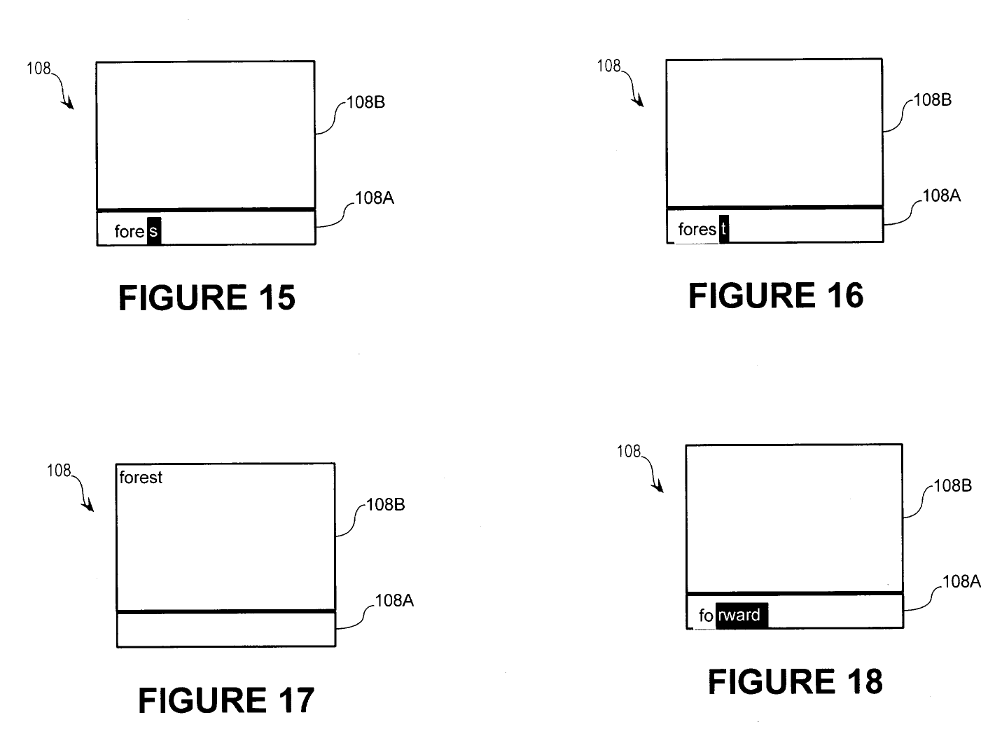

Subsequent iterations of the loop of steps 302-322 are performed analogously to the third iteration described above. In particular, processing by text input logic 226 includes steps 312 (through test steps 304 and 308 in sequence) and through test step 314 to next step 322. Thus far in this illustrative example, the user has pressed the following keys: 3-3-3-<pause>-6-<pause>-7. Accordingly, the number of words represented in general dictionary 708 matching the letters specified thus far is relatively small. Single key presses therefore can very likely specify each of the remaining letters of the intended word. The user therefore presses the following keys to complete the intended word: the “3” key to specify “e” (FIG. 14), the “7” key to specify “s” (FIG. 15), and the “8” key to specify “t” (FIG. 16).

After specifying the last letter “t,” the user presses a predetermined one of control keys 104 to indicate that the intended word is correctly represented in window 108A. Accordingly, processing by text input logic 226 (FIG. 2) transfers through test step 314 (FIG. 3) to step 316 in which text input logic 226 appends the specified word represented in window 108A (FIG. 16) to a text message maintained by text input logic 226. Processing transfers to steps 318 and 320 in which text input logic 226 (FIG. 2) respectively clears window 108A (FIG. 17) and displays the current full text message, including the word appended in step 316 (FIG. 3), in window 108B (FIG. 17).

Thus, to specify the word “forest” according to the present invention, the user performs eight (8) key presses: 3-3-3-6-7-3-7-8. By contrast, specifying “forest” using conventional multitap requires fifteen (15) key presses: 3-3-3-6-6-6-7-7-7-3-3-7-7-7-7-8. Text entry according to the present invention is therefore considerably more efficient than conventional multi-tap systems. In addition, by adding only two additional key presses (e.g., the two extra presses of the “3” key to unambiguously specify the letter “f” as the first letter) and by predicting the second character according to frequency of use of bigrams, predictive analysis of subsequent key presses is significant improved. In particular, since any predicted words at least begin with the same letter as that intended by the user, the predicted words seem closer to that intended by the user and therefore seem more nearly associated with the intended word in the user's mind. In addition, words and/or subsequent letters predicted by text input logic 226 (FIG. 2) are closer to those intended by the user. The overall experience is therefore significantly improved for the user.

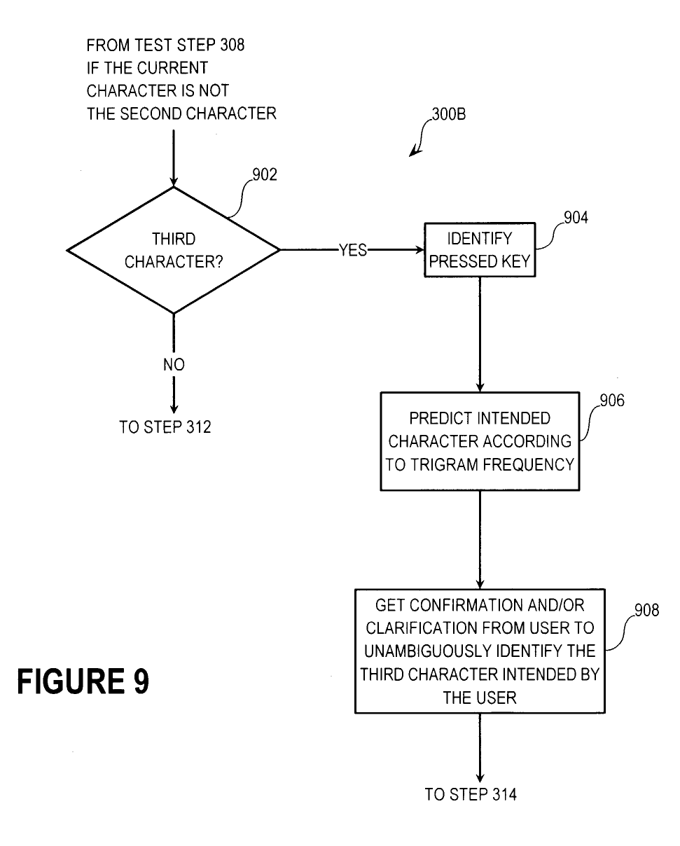

While the embodiment described above uses word frequency in predictive analysis pertaining to a third character specified by the user, predictive analysis pertaining to a third character entered by the user involves trigram frequency in an alternative embodiment. This alternative embodiment is represented in logic flow diagram 300B (FIG. 9) which shows a modification to logic flow diagram 300 (FIG. 3). In particular, logic flow diagram 300B (FIG. 9) shows a test step 902 interposed between test 308 and step 312.

In test step 902, text input logic 226 determines whether the current character processed in the current iteration of the loop of steps 302-322 (FIG. 3) is the third character of the current word. Text input logic 226 makes such a determination by determining that the character processed in the immediately preceding iteration of the loop of steps 302-322 was the second character of the current word.

If the current character is not the third character, processing transfers to step 312 which is described above. However, step 312 is slightly different than as described above. In particular, predictive database 228 (FIG. 7) includes a trigram table 706 which is generally analogous to bigram table 704 except that an individual element of trigram table 706 corresponds to a pressed key and a preceding bigram.

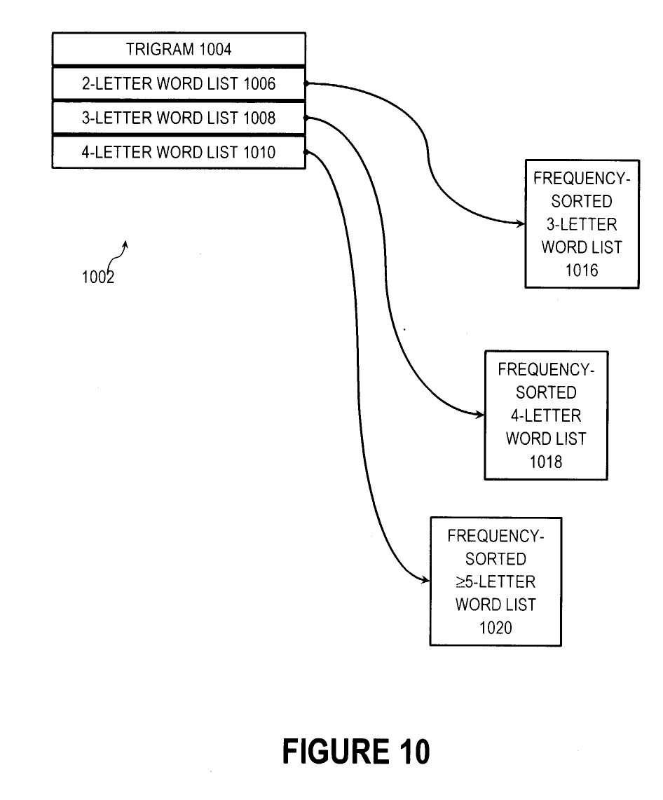

In addition, trigrams are represented slightly differently within general dictionary 608. A trigram record 1002 (FIG. 10) of general dictionary 608 includes a trigram field 1002, which is analogous to bigram field 804 (FIG. 8), and word list pointers 1006-1010 (FIG. 10), which are generally analogous to word list pointers 806-812 (FIG. 8). Specifically, word list pointers 1006-1010 (FIG. 10) refer to ordered words lists 1016-1020, respectively. Ordered word list 1016 includes words which are three characters in length. Ordered word list 1018 includes words which are four characters in length. And ordered word list 1020 includes words which are at least five characters in length.

With the exception of these few differences, step 312 is performed in the manner described above when trigrams are processed in the manner illustrated in logic flow diagram 300B (FIG. 9).

Conversely in test step 902, if the current character is the third character, processing transfers to step 904. In step 904, text input logic 226 identifies the pressed key in the manner described above with respect to step 402 (FIG. 4).

In step 906 (FIG. 9), text input logic 226 predicts the intended character according to trigram frequency. Step 906 is analogous to step 404 (FIG. 4) as described above except that trigram table 606 (FIG. 6) is used in lieu of bigram table 604. As described above, trigram table 606 is generally analogous to bigram table 604 as described above except that trigram table 606 is predicated on a preceding bigram rather than a preceding first character.

In step 908 (FIG. 9), text input logic 226 gets confirmation and/or clarification from the user to unambiguously identifier the third character as intended by the user in a manner analogous to that described above with respect to step 406 (FIG. 4). From step 908 (FIG. 9), processing transfers to step 312 (FIG. 3) which is described above.

Thus, in this alternative embodiment, the first character is specified by the user unambiguously, the second character is predicted according to bigram usage frequency, the third character is predicted according to trigram usage frequency, and additional characters are predicted according to word usage frequency. As with the embodiment described above, such predicts each successive character with increasing accuracy such that the user is not presented with predicted word candidates which are substantially different from the user's intended word. Accordingly, the user's experience is both efficient and comforting.

As described above, latter characters are predicted according to word usage frequency as represented in general dictionary 708 (FIG. 7). In another alternative embodiment, a personal dictionary 710 (FIG. 7) is included in predictive database 228 to record word usage frequency and/or recency specific to an individual user and personal dictionary 710 is used to predict word candidates intended by the user. As a result, behavior of text input logic 226 adapts to the word usage of the user to improve even further the accuracy with which intended words are predicted.

In this illustrative embodiment, personal dictionary 710 stores a relatively small number of words which are not included in general dictionary 708 in a simple list sorted according to recency of use. Of course, to save processing resources in mobile telephone 100, simple pointer logic is used to maintain the order of words stored in personal dictionary 710. To maintain recency of use as represented in personal dictionary 710, words located within personal dictionary 710 and specified by the user are moved to the position of the most recently used word within personal dictionary 710. Accordingly, frequently used words tend to be kept within personal dictionary 710 according to the least recently used mechanism described herein.

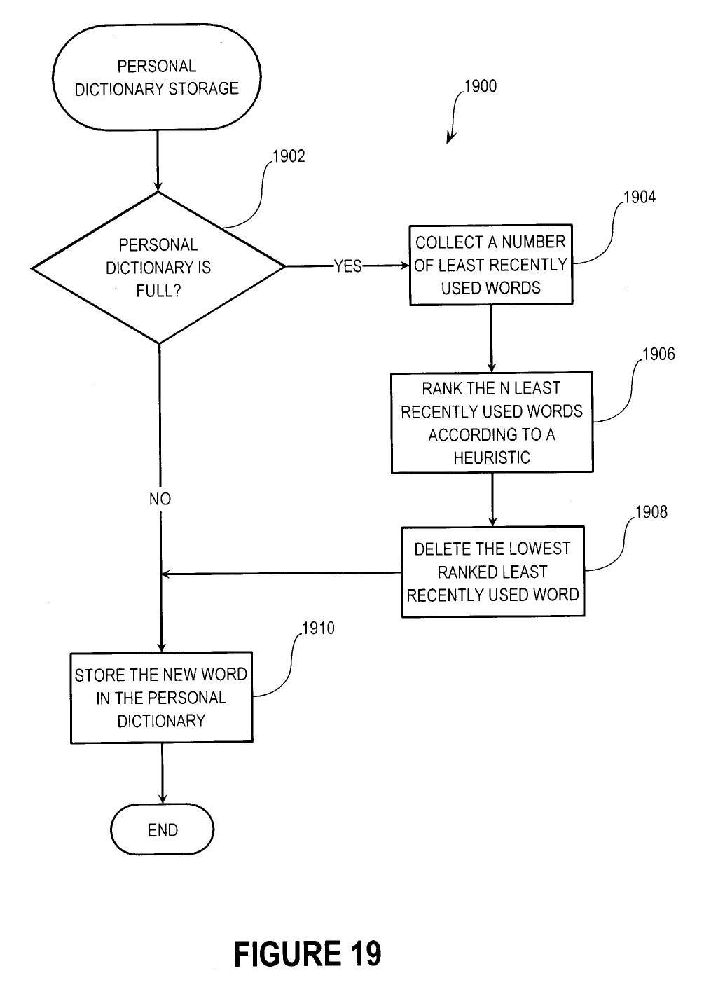

In a slightly more complex, alternative embodiment, recency (and therefore frequency) of use is combined with other factors in determining which entry of a full personal dictionary 710 to delete or overwrite when a word specified by the user is to be written to personal dictionary 710. This embodiment is illustrated in logic flow diagram 1900 (FIG. 19).

In test step 1902, text input logic 226 (FIG. 2) determines whether personal dictionary 710 is full. If not, text input logic 226 stores the word specified by the user in personal diction 710 in step 1910 and processing according to logic flow diagram 1900 completes. Conversely, if personal dictionary 710 is full, the newly specified word must display another word within personal dictionary 710 and processing transfers to step 1904.

In step 1904, text input logic 226 collects a number of least recently used words of personal dictionary 710. In this illustrative embodiment, personal dictionary 710 stores a total of 200 words and the 100 least recently used words are collected in step 1904. There are a number of ways by which the least recently used words can be efficiently determined. In one embodiment, pointer logic forms a doubly-linked list of words within personal dictionary 710 and a pointer is maintained to identify the 100^{th} least recently used word. In an alternative embodiment, a word sequence number is incremented each time a word is added to personal dictionary 710 and the a sequence number of the newly stored or updated word represents the current value of the word sequence number. The 100^{th} least recently used words are all words whose sequence number is less than the current word sequence number less one hundred. Other mechanisms for determining the one hundred least recently used words within personal dictionary 710 can be determined by application of routine engineering.

In step 1906, text input logic 226 ranks the collected words according to a heuristic. In this illustrative embodiment, the heuristic involves word length and/or use of upper-case letters. Longer words are more difficult to enter using a reduced keypad and are therefore preferred for retention within personal dictionary 710. In particular, it is more helpful to the user to predict longer words than to predict shorter words since accurate prediction of longer words saves a greater number of key presses by the user. Use of upper-case letters in a word represents a form of emphasis by the user and therefore indicates a level of importance attributed by the user. Accordingly, words which include one or more upper-case letters are given preference with respect to retention within personal dictionary 710.

In this illustrative embodiment, the collected least recently used words are ranked first by word length and then, within words of equivalent length, are ranked according to use of upper-case letters. Within groups of words of equivalent length and equivalent use of upper-case letters, the relative recency of use is maintained.

In step 1908, the lowest ranked of the collected least recently used words is removed from personal dictionary 710. The newly specified word is added in step 1910. Removal in step 1908 can be by explicit deletion prior to storage of step 1910 or can be by overwriting the newly specified word in step 1910 in the same record within personal dictionary 710.

Thus, according to the described implementation of logic flow diagram 1900, the shortest of the one hundred least recently used words of personal dictionary 710 is superseded by the newly specified word. If two or more words of the shortest of the one hundred least recently used words are of equivalent length, the word with the least use of upper-case letters is superseded. If two or more of the shortest of the one hundred least recently used words are of equivalent length and equivalent use of upper-case letters, the one of those words which is least recently used is superseded.

The above description is illustrative only and is not limiting. For example, while text messaging using a wireless telephone is described as an illustrative embodiment, it is appreciated that text entry in the manner described above is equally applicable to many other types of text entry. Wireless telephones use text entry for purposes other than messaging such as storing a name of the wireless telephone's owner and associating textual names or descriptions with stored telephone numbers. In addition, devices other than wireless telephones can be used for text messaging, such as two-way pagers and personal wireless e-mail devices. Personal Digital Assistants (PDAs) and compact personal information managers (PIMs) can utilize text entry in the manner described here to enter contact information and generally any type of data. Entertainment equipment such as DVD players, VCRs, etc. can use text entry in the manner described above for on-screen programming or in video games to enter names of high scoring players. Video cameras with little more than a remote control with a numeric keypad can be used to enter text for textual overlays over recorded video. Text entry in the manner described above can even be used for word processing or any data entry in a full-sized, fully-functional computer system.

Therefore, this description is merely illustrative, and the present invention is defined solely by the claims which follow and their full range of equivalents.

What is claimed is:

1. A method for generating text in response to signals generated by a user, the method comprising:
receiving signals generated by the user which specify a first character of a word of the text;
receiving signals generated by the user which specify a collection of one or more candidate characters which can be a second character of the word;
predicting that an intended one of the one or more candidate characters is intended by the user according to relative frequency of usage the intended character adjacent to the first character; and
presenting the intended character to the user for confirmation.

2. The method of claim 1 wherein predicting comprises:
determining the relative frequency of usage of a bigram including the first character and the intended character.

3. The method of claim 2 wherein the relative frequency of usage of the bigram is relative to frequency of usage of respective bigrams including the first character and respective other ones of the one or more candidate characters.

4. The method of claim 1 wherein the signals which specify the first character specifies the first character unambiguously.

5. The method of claim 4 wherein the signals which specify the first character specifies the first character according to a multi-tap data entry technique.

6. The method of claim 1 wherein the signals which specify the collection represent a single user data input gesture.

7. The method of claim 6 wherein the single user data input gesture is a single button press.

8. A method for generating text in response to signals generated by a user, the method comprising:
receiving signals generated by the user which specify first and second characters of a word of the text;
receiving signals generated by the user which specify a collection of one or more candidate characters which can be a third character of the word;
predicting that an intended one of the one or more candidate characters is intended by the user according to relative frequency of usage the first, second, and intended characters in sequence; and
presenting the intended character to the user for confirmation.

9. The method of claim 8 wherein predicting comprises:
determining the relative frequency of usage of a trigram including the first, second, and intended characters.

10. The method of claim 9 wherein the relative frequency of usage of the trigram is relative to frequency of usage of respective trigrams including the first and second characters and respective other ones of the one or more candidate characters.

11. The method of claim 8 wherein the signals which specify the first and second characters specify the first and second characters unambiguously.

12. The method of claim 11 wherein the signals which specify the first and second characters specify the first and second characters according to a multi-tap data entry technique.

13. The method of claim 8 wherein the signals which specify the collection represent a single user data input gesture.

14. The method of claim 13 wherein the single user data input gesture is a single button press.

15. A computer readable medium useful in association with a computer which includes a processor and a memory, the computer readable medium including computer instructions which are configured to cause the computer to generate text in response to signals generated by a user by:
receiving signals generated by the user which specify a first character of a word of the text;
receiving signals generated by the user which specify a collection of one or more candidate characters which can be a second character of the word;
predicting that an intended one of the one or more candidate characters is intended by the user according to relative frequency of usage the intended character adjacent to the first character; and
presenting the intended character to the user for confirmation.

16. The computer readable medium of claim 15 wherein predicting comprises:
determining the relative frequency of usage of a bigram including the first character and the intended character.

17. The computer readable medium of claim 16 wherein the relative frequency of usage of the bigram is relative to frequency of usage of respective bigrams including the first character and respective other ones of the one or more candidate characters.

18. The computer readable medium of claim 15 wherein the signals which specify the first character specifies the first character unambiguously.

19. The computer readable medium of claim 18 wherein the signals which specify the first character specifies the first character according to a multi-tap data entry technique.

20. The computer readable medium of claim 15 wherein the signals which specify the collection represent a single user data input gesture.

21. The computer readable medium of claim 20 wherein the single user data input gesture is a single button press.

22. A computer readable medium useful in association with a computer which includes a processor and a memory, the computer readable medium including computer instructions which are configured to cause the computer to generate text in response to signals generated by a user by:
receiving signals generated by the user which specify first and second characters of a word of the text;
receiving signals generated by the user which specify a collection of one or more candidate characters which can be a third character of the word;
predicting that an intended one of the one or more candidate characters is intended by the user according to relative frequency of usage the first, second, and intended characters in sequence; and
presenting the intended character to the user for confirmation.

23. The computer readable medium of claim 22 wherein predicting comprises:
determining the relative frequency of usage of a trigram including the first, second, and intended characters.

24. The computer readable medium of claim 23 wherein the relative frequency of usage of the trigram is relative to frequency of usage of respective trigrams including the first and second characters and respective other ones of the one or more candidate characters.

25. The computer readable medium of claim 22 wherein the signals which specify the first and second characters specify the first and second characters unambiguously.

26. The computer readable medium of claim 25 wherein the signals which specify the first and second characters specify the first and second characters according to a multi-tap data entry technique.

27. The computer readable medium of claim 22 wherein the signals which specify the collection represent a single user data input gesture.

28. The computer readable medium of claim 27 wherein the single user data input gesture is a single button press.

29. A computer system comprising:
a processor;
a memory operatively coupled to the processor; and
a data entry module (i) which executes in the processor from the memory and (ii) which, when executed by the processor, causes the computer to generate text in response to signals generated by a user by:
receiving signals generated by the user which specify a first character of a word of the text;
receiving signals generated by the user which specify a collection of one or more candidate characters which can be a second character of the word;
predicting that an intended one of the one or more candidate characters is intended by the user according to relative frequency of usage the intended character adjacent to the first character; and
presenting the intended character to the user for confirmation.

30. The computer system of claim 29 wherein predicting comprises:
determining the relative frequency of usage of a bigram including the first character and the intended character.

31. The computer system of claim 30 wherein the relative frequency of usage of the bigram is relative to frequency of usage of respective bigrams including the first character and respective other ones of the one or more candidate characters.

32. The computer system of claim 29 wherein the signals which specify the first character specifies the first character unambiguously.

33. The computer system of claim 32 wherein the signals which specify the first character specifies the first character according to a multi-tap data entry technique.

34. The computer system of claim 29 wherein the signals which specify the collection represent a single user data input gesture.

35. The computer system of claim 34 wherein the single user data input gesture is a single button press.

36. A computer system comprising:
a processor;
a memory operatively coupled to the processor; and
a data entry module (i) which executes in the processor from the memory and (ii) which, when executed by the processor, causes the computer to generate text in response to signals generated by a user by:
receiving signals generated by the user which specify first and second characters of a word of the text;
receiving signals generated by the user which specify a collection of one or more candidate characters which can be a third character of the word;
predicting that an intended one of the one or more candidate characters is intended by the user according to relative frequency of usage the first, second, and intended characters in sequence; and
presenting the intended character to the user for confirmation.

37. The computer readable medium of claim 36 wherein predicting comprises:
determining the relative frequency of usage of a trigram including the first, second, and intended characters.

38. The computer readable medium of claim 37 wherein the relative frequency of usage of the trigram is relative to frequency of usage of respective trigrams including the first and second characters and respective other ones of the one or more candidate characters.

39. The computer readable medium of claim 36 wherein the signals which specify the first and second characters specify the first and second characters unambiguously.

40. The computer readable medium of claim 39 wherein the signals which specify the first and second characters specify the first and second characters according to a multi-tap data entry technique.

41. The computer readable medium of claim 36 wherein the signals which specify the collection represent a single user data input gesture.

42. The computer readable medium of claim 41 wherein the single user data input gesture is a single button press.
